(19) United States
(12) Patent Application Publication
(10) Pub. No.: US 2019/0186979 A1
(43) Pub. Date: Jun. 20, 2019

(54) LIQUID LEVEL MEASURING DEVICE

(71) Applicants: Ron Starinsky, Ramat Gan (IL); Ziv Hayat, Yaffe (IL); Nimrod Shalvi, Closter, NJ (US); Amit Shefi, Aseret (IL); Or Shefi, Aseret (IL)

(72) Inventors: Ron Starinsky, Ramat Gan (IL); Ziv Hayat, Yaffe (IL); Nimrod Shalvi, Closter, NJ (US); Amit Shefi, Aseret (IL); Or Shefi, Aseret (IL)

(21) Appl. No.: 16/219,455

(22) Filed: Dec. 13, 2018

(30) Foreign Application Priority Data
Dec. 17, 2017 (IL) 256362

(51) Int. Cl. G01F 23/296; A47G 23/16

(52) U.S. Cl. CPC G01F 23/2962; G01F 23/26; A47G 23/16

(57) ABSTRACT

A liquid level measuring device, comprising: at least one Time-of-Flight (TOF) ranging sensor for enabling to obtain the distance between the at least one sensor and the liquid level within a liquid retaining device that has a narrow neck portion, wherein each TOF ranging sensor is configured to emit a narrow width light ray, thereby enabling to measure the distance without interference from the neck portion of the liquid retaining device; a controlling unit for collecting data in accordance with the measurements of the at least one TOF ranging sensor; and a wireless communication module for forwarding to a remote computing device the collected data or data relative to the collected data.

### CROSS REFERENCE TO RELATED APPLICATION

This application claims priority to Israeli application number 256362 filed on Dec. 17, 2017, which is incorporated herein by reference in its entirety.

### FIELD OF THE INVENTION

The present invention relates to the field of liquid level measuring systems. More particularly, the invention relates to a liquid level measuring device that may be used to measure, record, and monitor in real-time liquid level in portable liquid retaining devices, such as bottles.

### BACKGROUND OF THE INVENTION

Storage management is one of the most important tasks in almost every business. It starts with the capability to know at any moment how much was used and how much left. It grows more and more complicated when there are multiple consumers, and very low rate or accuracy of documentation. In cases of fluid management the difficulty grows even more, due to the facts that fluids are hard to measure without proper tools, and that multiple dispensing stations make the real-time manual measuring almost impossible.

For example, US Patent application 2016/0180690 discloses a device to measure the material level inside a container. This application uses optical sensor for measuring the material level inside the container. However, for the use of measurement inside a relatively narrow container with a relatively narrow neck portion (e.g., where the diameter of the neck is usually about 1-2 centimeters, such as the body and neck form of a common liquor bottle), using light emitter and receiver to extract range for content measurement will suffer from inconsistency and inaccuracy because of multipath effect created by the width of the light emitter ray. Another major disadvantage is the sensitivity to ambient light caused by the wavelength bandwidth of the receiver (it is needed to be large so there will always be overlapping with the emitting ray).

Some other technologies we have tested has such as sampling sound or echo generated by sonic or ultra-sonic waves, e.g., as disclosed in US Patent application 2016/0025545 and also in Patent application 2016/0180690, has proven in effective for liquor bottle content measurement for both mechanical issues (liquid isolation and durability) and inaccuracy (caused by reflections and soundwave interferences due to the small space and the large wavelength).

At present there is no reliable solution that is able to accurately monitor liquid level in portable liquid retaining devices, in particular such as liquor bottles due to their actual difficulties created by their mechanical structure.

To address these problems and to provide a real-time fluid inventory management, with multiple unmonitored dispensing units (which is an impossible task these days), a reliable sensor solution that enables narrow width light and ambient light filtering is required.

It is an object of the present invention to provide a device that is capable of providing a reliable level measurement inside a narrow container such as a liquor bottle neck.

It is another object of the present invention to provide a system for precise automatic measuring and reporting volume of fluids with the use of a computerized process.

### SUMMARY OF THE INVENTION

As a solution for the abovementioned issues, the present invention provides a device that uses a Time-of-Flight (TOF) based technology for reliable sensor solution. The device is configured to provide a narrow width light ray (e.g., by using VCSEL Laser emitter) and an ambient light filtering thanks to its narrow bandwidth receiver. The TOF range measurement is absolute and thereby helps to overcome the challenges when facing content measurement in narrow liquid retaining devices such liquor bottles.

The present invention relates to a liquid level measuring device, comprising:

a) at least one Time-of-Flight (TOF) ranging sensor for enabling to obtain the distance between said at least one sensor and the liquid level within a liquid retaining device;

b) a controlling unit for collecting data in accordance with the measurements of said at least one TOF ranging sensor; and

c) a wireless communication module for forwarding to a remote computing device said collected data and/or data relative to said collected data.

According to an embodiment of the invention, the device further comprises an angle sensor for enabling to measure the liquid level within the liquid retaining device only when said liquid retaining device is leveled or positioned in a predetermined measuring position.

According to an embodiment of the invention, the remote computing device is a cloud computing.

According to an embodiment of the invention, the remote computing device is a user interface device, in particular a smartphone.

According to an embodiment of the invention, the collected data is being forwarded to the remote computing device via a gateway.

According to an embodiment of the invention, the at least one TOF ranging sensor is configured to emit a narrow width light ray, thereby enabling to measure the distance without interference from a neck portion of a liquid retaining device, in particular a liquor bottle.

According to an embodiment of the invention, the narrow width light ray is about 980 nm wavelength.

According to an embodiment of the invention, the at least one TOF ranging sensor is configured to provide an ambient light filtering.

According to an embodiment of the invention, the at least one TOF ranging sensor comprises a vertical-cavity surface-emitting laser (VCSEL) diode.

According to an embodiment of the invention, the device is a portable unit in the form of a lid or cap that is suitable to seal the liquid retaining device, in particular by being mounted on top of an opening of said liquid retaining device.

In another aspect, the present invention relates to a system for providing automatic measuring and reporting volume of liquid in a liquid retaining device, comprising:

a) a liquid level measuring device that comprises i) at least one Time-of-Flight (TOF) ranging sensor for enabling to obtain the distance between said at least one sensor and the liquid level within a liquid retaining device, ii) a controlling unit for collecting data in accordance with the measurements of said at least one TOF ranging sensor, and c) a wireless communication module for forwarding to a remote computing device said collected data or data relative to said collected data;

b) a remote computing device for storing and preforming data analysis on data originated from the liquid level measuring device; and

c) a gateway for connecting one or more liquid level measuring devices to the remote computing device through a communication network.

According to an embodiment of the invention, the system further comprising a mobile communication device that is configured to serve as a gateway to connect one or more liquid level measuring devices to the remote computing device.

According to an embodiment of the invention, the mobile communication device is used as a user interface device, in particular for displaying analyzed data from remote computing device.

In yet another aspect, the present invention relates to a method of measuring liquid level within a liquid retaining device, comprising:

a) measuring the distance between at least one Time-of-Flight (TOF) ranging sensor and the liquid level within the liquid retaining device by emitting a narrow width light ray of about 980 nm wavelength;

b) collecting data in accordance with the measurements of said at least one TOF ranging sensor; and

c) forwarding to a remote computing device said collected data or data relative to said collected data.

### BRIEF DESCRIPTION OF THE DRAWINGS

In the drawings:

FIG. 1 schematically illustrates a liquid measuring system that includes a liquid level measuring device in form of a smart bottle cap, according to an embodiment of the invention; and

FIG. 2 is a block diagram that illustrates the liquid level measuring device of the system of FIG. 1, according to an embodiment of the invention.

### DETAILED DESCRIPTION OF THE INVENTION

Throughout this description the term “liquid retaining device” is used to indicate an essentially vertical container adapted to hold liquid material, such as water, alcoholic beverage, carbonated or soft drinks and the like. This term does not imply any shape, construction material or geometry, and invention is applicable to all suitable liquid holding containers that can be sealed with a corresponding lid or cap.

The present invention provides a liquid level measuring device that may be used to provide real-time information regarding the volume of a liquid in a liquid retaining device. According to an embodiment of the invention, the liquid level measuring device is a portable unit in the form of a lid or cap that is suitable to seal the liquid retaining device (e.g., by being mounted on top of an opening of a liquor bottle). For example, the liquid level measuring device may replace the original/existing lid or cap of a beverage bottle, i.e., provide a smart bottle cap to an existing liquid retaining device, such as a liquor bottle.

Data collected from the liquid level measuring device (e.g., the smart bottle cap) can be wirelessly transmitted to a remote location for processing or can be processed, at least partially, by a processing module embedded within the liquid level measuring device itself. The collected data can be processed to provide relevant information about liquid consumption and remain volume of liquid in each specific liquid retaining device. According to some embodiments of the invention, the information can be accessed through software applications (e.g., mobile apps) or other dedicated software programs developed for this purpose for use on a mobile device such as a smartphone or as an interface for personal computers, remote monitoring systems, and other electronic systems are configured to exchange information. For example, in storage management, the app may generate alerts regarding the need to order specific type of drinks before they will run-out of stock.

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

The system and method of the present invention will now be described with respect to an eco-system for liquor inventory management, for purpose of illustration only. As will be appreciated by a person skilled in the art, such eco-system can be utilized to other purposes or usages, such as self-consumption monitoring system for an individual user.

According to an embodiment of the invention, the eco-system for liquor inventory management consists of several parts. There is a liquid level measuring device in the form of a smart bottle cap that refers herein as the “Endpoint”, a central unit that connects one or more endpoints to a remote computing device over the internet, which refers herein as the “Gateway”, and the remote computing device that is associated with a database for storing and preforming data analysis, which refers herein as the “Cloud”. The smart bottle cap contains at least a measuring device and a communication module. The raw outcome of the measuring is transmitted, from the endpoint (e.g., by a wireless communication module of the endpoint) via the gateway, to the cloud, there it processed to extract the amount of fluid left in the bottle and stored in a database. According to other embodiments, the invention may be practiced in distributed computing environments where tasks are performed by remote computing devices (e.g., the cloud) that are linked through one or more communication networks. In a distributed computing environment, program modules (that perform tasks relative to raw outcome of the measuring) may be in both local and remote memory storage devices (e.g., at the endpoint and at the cloud). For example, the amount of fluid left in a liquid retaining device may be processed in the endpoint, and the cloud will process the incoming data to deduce conclusion regarding cluster of data collected from the endpoints.

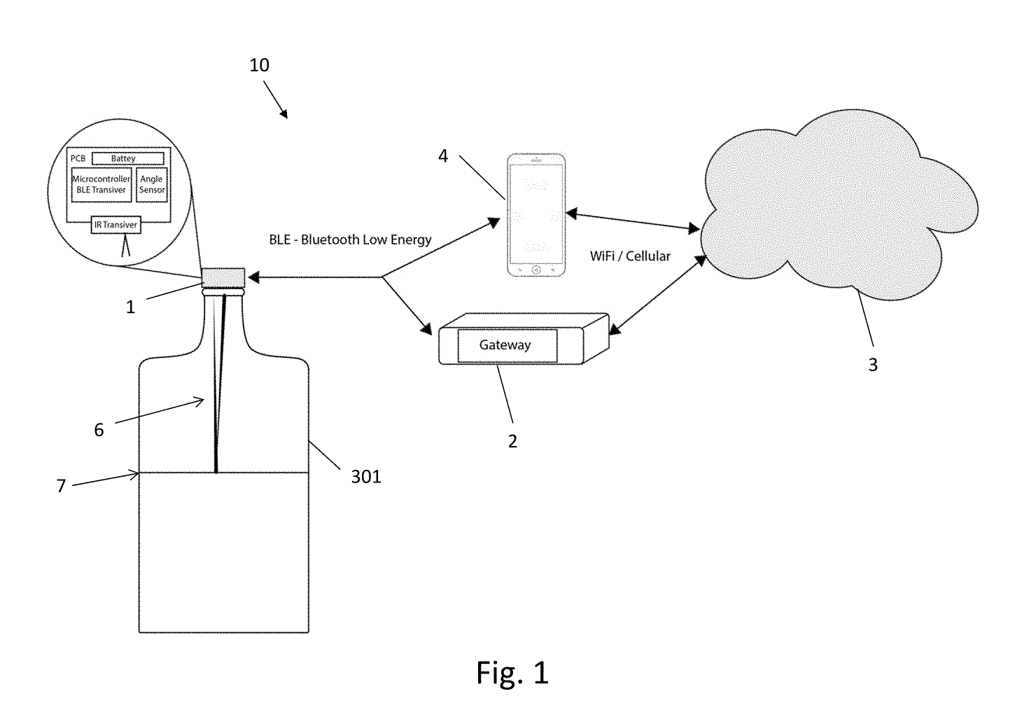

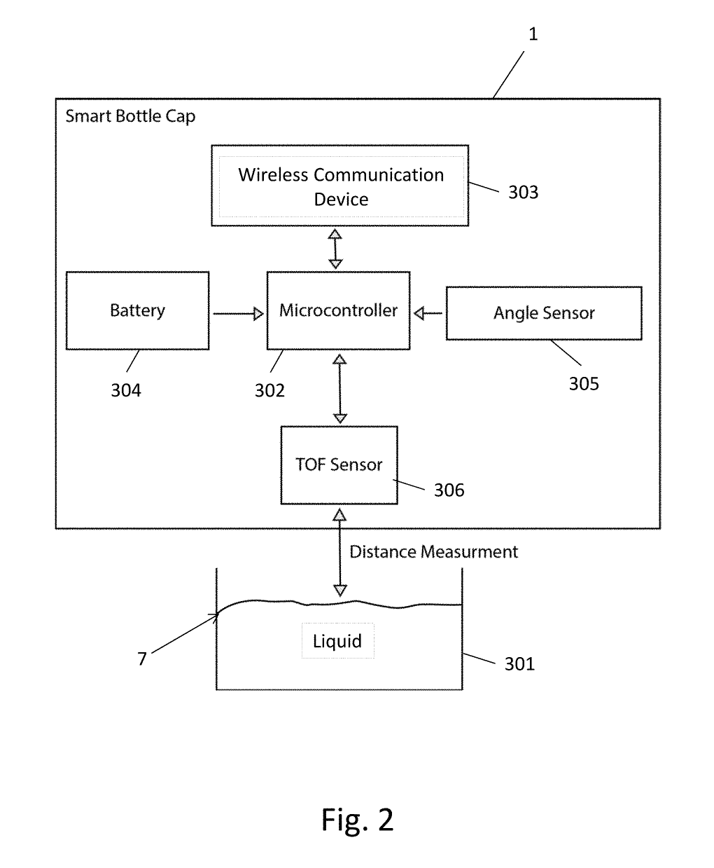

Referring now to FIGS. 1-2, according to an embodiment of the invention, an eco-system 10 of the present invention comprises an endpoint in form of a smart bottle cap 1 (i.e., the liquid level measuring device), a gateway 2 and a cloud 3. In some embodiments, a mobile communication device 4 (e.g., a smartphone) may serve as a gateway to connect the endpoints (i.e., smart bottle cap 1) to cloud 3. In addition, mobile communication device 4 may also be used as a user interface device (e.g., displaying analyzed data from cloud 3).

Smart bottle cap 1 should be mounted on a corresponding opening of a bottle 301 (i.e., a liquid retaining device) as a default. A controlling unit 302 configured to perform tasks relative to the measured data and to send data for cloud 3, a Time-of-Flight (TOF) ranging sensor 306 that is used to measure the time until an emitted ray returns from the surface of the liquid within bottle 301, a wireless communication module 303 (e.g., a Bluetooth module, a Wi-Fi module, etc.) to communicate with other devices, an optional angle sensor 305 to provide more accurate data by enabling to measure the liquid level only when bottle 301 is leveled or positioned in a predetermined measuring position, and a power source 304 (e.g., a battery or a rechargeable battery).

TOF ranging distance measurement sensor 306 configured to emit light signals (e.g., an IR Laser light) to the surface of the liquid within bottle 301 and to measure the time it takes for the light to reach a corresponding detector (e.g., which is built into sensor 306). For example, sensor 306 can be an Infra-Red (IR) transceiver such as VL6180X, VL52L0X provided by STMicroelectronics

According to an embodiment of the invention, measurement of the liquid level in the bottle is performed by using TOF ranging distance measurement sensor 306 that comprises a light emitter and receiver. For optimal measuring results, sensor 306 should emit light source at about 980 nm wavelength from a vertical-cavity surface-emitting laser (VCSEL) diode. The 980 nm wavelength enables a narrow light beam that is mandatory for measuring distance without interference from a neck of the bottle on which cap 1 is mounted. In addition, VCSEL diode and the narrow light beam excel at filtering sunlight and other background noises.

The measurement itself performed by emitting light source and receiving the reflected light from the surface of the liquid, the travel time of the light is then used to obtain the distance between the surface of the liquid and the receiver of sensor 306.

Such an implantation of sensor 306 (i.e., in terms of the wavelength and narrow light beam) also enables to mechanically isolate it from the measured substance in terms of liquid exposure durability (liquid resistance, alcohol endurance etc.).

Measuring the bottle state is made by the inertial sensor combining with optic measurement, while cap is open we can expect non-vertical position of the bottle and irrational liquor level measurement, we have developed an algorithm to dedicate from this data set the bottle state. Optionally, the smart bottle cap 1 may further comprise additional sensors that can be used to measure temperature and humidity to realize liquid wellness over time.

Due to size limitation of cap 1 (e.g., as it may be used as a replacement lid for common beverage bottles or it can be designed to be implemented within a bottle cap), controlling unit 302 can be a computer system on a chip (e.g., a microcontroller, a system on a chip, and the like) and it may contain an integrated processor, memory (a small amount of RAM, program memory, or both), and programmable input/output peripherals, which can be used to interact with different elements such as sensor 306, wireless communication module 303, etc.

When a measure need to be executed, either by pre-programmed timer or other form of pre-defined trigger, according to readings of angle sensor 305, or by external demand (e.g., as received via wireless communication module 303), controlling unit 302 sends the command to the TOF sensor 306 and waits for response. The TOF sensor 306 sends a ray to the surface of the liquid and records the time it took the light to reflect to sensor 306. The controlling unit 302 may forward the collected raw data via wireless communication module 303 to a remote computing device, such as cloud 3, via gateway 2 or communication device 4.

According to an embodiment of the invention, gateway 2 may comprise a dual direction Wi-Fi module for medium range fast communication, a dual direction Bluetooth module for short range low energy communication, a processor to manage the data traffic, and a backup battery to ensure communication even when the power supply from the network is down.

Gateway 2 links between smart bottle cap 1 (or more than one smart bottle cap 1) and cloud 3, where the database is, and where the calculations and manipulation of data are done.

The complete system is composed of four types of entities. A set of smart bottle caps 1 distinguished by private ID, gateway 2, cloud 3, and one or more mobile communication device 4 that can be used as user interface devices. The raw data flow from caps 1 through gateway 2 to cloud 3, where the data is processed and stored. A dedicated application connected to cloud 3 can show statistics and individual data on the mobile communication device 4 or it can be used other relevant tasks.

As aforementioned hereinabove, in some cases, the mobile communication device 4 can be used as a gateway; if needed and if it contains the involved hardware. In such cases, wireless communication module 303 may communicate with a corresponding mobile communication device 4 (and optionally thereby to communicate with cloud 3). Wireless communication module 303 may use Bluetooth, ZigBee, Wi-Fi, or any other suitable data communication arrangement as a communication medium for wirelessly transmitting data. Mobile communication device 4 can be a smartphone, a tablet or any other computing device that allows access to the data collected by cap 1 and/or processed by cloud 3 (or other remote computing device) through software applications such as mobile apps.

As will be appreciated by the skilled person the arrangement described in the figures results in a liquid level measuring device that is capable of measuring, recording, and monitoring in real-time the liquid level in portable liquid retaining devices, such as bottles. In addition, the system of the present invention also capable of measuring the amount of liquid used or consumed and accordingly generating alerts and notifications upon preconfigured thresholds.

All the above description and examples have been given for illustration and are not intended to limit the invention in any way. Many different TOF measuring arraignments, methods of analysis the liquid consumption, electronic and logical elements can be employed, all without exceeding the scope of the invention.

1. A liquid level measuring device, comprising:
a) at least one Time-of-Flight (TOF) ranging sensor for enabling to obtain the distance between said at least one sensor and the liquid level within a liquid retaining device that has a narrow neck portion, wherein each TOF ranging sensor is configured to emit a narrow width light ray, thereby enabling to measure the distance without interference from the neck portion of the liquid retaining device;
b) a controlling unit for collecting data in accordance with the measurements of said at least one TOF ranging sensor; and
c) a wireless communication module for forwarding to a remote computing device said collected data or data relative to said collected data.

2. The device according to claim 1, further comprising an angle sensor for enabling to measure the liquid level within the liquid retaining device only when said liquid retaining device is leveled or positioned in a predetermined measuring position.

3. The device according to claim 1, wherein the remote computing device is a cloud computing.

4. The device according to claim 1, wherein the remote computing device is a user interface device, in particular a smartphone.

5. The device according to claim 1, wherein the collected data is being forwarded to the remote computing device via a gateway.

6. The device according to claim 1, wherein the liquid retaining device is a liquor bottle. The device according to claim 6, wherein the narrow width light ray is about 980 nm wavelength.

8. The device according to claim 1, wherein the at least one TOF ranging sensor is configured to provide an ambient light filtering.

9. The device according to claim 1, wherein the at least one TOF ranging sensor comprises a vertical-cavity surface-emitting laser (VCSEL) diode.

10. The device according to claim 1, wherein the device is a portable unit in the form of a lid or cap that is suitable to seal the liquid retaining device, in particular by being mounted on top of an opening of said liquid retaining device.

11. A system for providing automatic measuring and reporting volume of liquid in a liquid retaining device that has a narrow neck portion, comprising:
a) a liquid level measuring device that comprises i) at least one Time-of-Flight (TOF) ranging sensor for enabling to obtain the distance between said at least one sensor and the liquid level within the liquid retaining device, wherein each TOF ranging sensor is configured to emit a narrow width light ray in order to measure the distance without interference from the neck portion of the liquid retaining device ii) a controlling unit for collecting data in accordance with the measurements of said at least one TOF ranging sensor, and c) a wireless communication module for forwarding to a remote computing device said collected data or data relative to said collected data;
b) a remote computing device for storing and preforming data analysis on data originated from the liquid level measuring device; and
c) a gateway for connecting one or more liquid level measuring devices to the remote computing device through a communication network.

12. A system according to claim 11, further comprising a mobile communication device that is configured to serve as a gateway to connect one or more liquid level measuring devices to the remote computing device.

13. A system according to claim 12, wherein the mobile communication device is used as a user interface device, in particular for displaying analyzed data from remote computing device.

14. A method of measuring liquid level for a liquid retaining device that has a narrow neck portion such as those of a common liquor bottle, comprising:
a) measuring the distance between at least one Time-of-Flight (TOF) ranging sensor and the liquid level within the liquid retaining device by emitting a narrow width light ray of about 980 nm wavelength through the narrow neck portion of said liquid retaining device;
b) collecting data in accordance with the measurements of said at least one TOF ranging sensor; and
c) forwarding to a remote computing device said collected data or data relative to said collected data.
